(19) United States
(12) Patent Application Publication
(10) Pub. No.: US 2013/0161540 A1
(43) Pub. Date: Jun. 27, 2013

(54) EXTREME ULTRAVIOLET LIGHT GENERATION APPARATUS

(71) Applicants: Shinji NAGAI, Hiratsuka-shi (JP); Osamu WAKABAYASHI, Hiratsuka-shi (JP)

(72) Inventors: Shinji NAGAI, Hiratsuka-shi (JP); Osamu WAKABAYASHI, Hiratsuka-shi (JP)

(73) Assignee: GIGAPHOTON INC

(21) Appl. No.: 13/560,310

(22) Filed: Jul. 27, 2012

(30) Foreign Application Priority Data
Dec. 26, 2011 (JP) 2011-283223

(51) Int. Cl. G21K 5/04

(52) U.S. Cl. 250/504 R

(57) ABSTRACT

An apparatus for generating extreme ultraviolet light (EUV) includes a chamber, a target supply unit, a collector mirror, an exhaust device, a gas supply device and an ultraviolet light source. The target supply unit supplies a target material to a predetermined region inside the chamber. The collector mirror collects EUV light generated from the target material. The exhaust device is connected to the chamber. The gas supply device is connected to the chamber to supply an etchant gas into the chamber. The ultraviolet light source irradiates a reflective surface of the collector mirror with ultraviolet light.

### CROSS-REFERENCE TO RELATED APPLICATION

The present application claims priority from Japanese Patent Application No. 2011-283223 filed Dec. 26, 2011.

### BACKGROUND

1. Technical Field

This disclosure relates to an apparatus for generating extreme ultraviolet (EUV) light.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used.

### SUMMARY

An apparatus according to one aspect of this disclosure for generating extreme ultraviolet light (EUV) may include a chamber, a target supply unit, a collector mirror, an exhaust device, a gas supply device, and an ultraviolet light source. The target supply unit is configured to supply a target material to a predetermined region inside the chamber. The collector mirror is configured to collect EUV light generated from the target material. The exhaust device is connected to the chamber. The gas supply device is connected to the chamber and configured to supply an etchant gas into the chamber. The ultraviolet light source is configured to irradiate a reflective surface of the collector mirror with ultraviolet light.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation apparatus.

FIG. 2 schematically illustrates an example of the configuration of an EUV light generation apparatus according to a first embodiment.

FIG. 3A schematically illustrates an example of the configuration of an EUV light generation apparatus according to a second embodiment.

FIG. 3B shows a far field profile of EUV light along IIIB-IIIB plane of FIG. 3A.

FIG. 3C is a sectional view schematically illustrating the configuration of the EUV light generation apparatus shown in FIG. 3A, taken along IIIC-IIIC plane.

FIG. 3C is another sectional view schematically illustrating the configuration of the EUV light generation apparatus shown in FIG. 3A, taken along IIID-IIID plane.

FIG. 3E is a perspective view of a pipe in a gas supply device according to the second embodiment.

FIG. 3F is a sectional view of the pipe in the gas supply device according to the second embodiment.

FIG. 4 schematically illustrates an example of the configuration of an EUV light generation apparatus according to a third embodiment.

FIG. 5A schematically illustrates an example of the configuration of an EUV light generation apparatus according to a fourth embodiment.

FIG. 5B is a sectional view schematically illustrating the configuration of the EUV light generation apparatus shown in FIG. 5A, taken along VB-VB plane.

FIG. 5C is a perspective view of a pipe in a gas supply device according to the fourth embodiment.

FIG. 5D is a sectional view of the pipe in the gas supply device according to the fourth embodiment.

### DETAILED DESCRIPTION

Hereinafter, selected embodiments of this disclosure will be described in detail with reference to the accompanying drawings. The embodiments to be described below are merely illustrative in nature and do not limit the scope of this disclosure. Further, the configuration(s) and operation(s) described in each embodiment are not all essential in implementing this disclosure. Note that like elements are referenced by like reference numerals and characters, and duplicate descriptions thereof will be omitted herein.

### Contents

1. Overview

2. Overview of EUV Light Generation System

2.1 Configuration

2.2 Operation

3. EUV Light Generation Apparatus Including Gas Supply Device and Ultraviolet Light Source: First Embodiment

3.1 Configuration

3.2 Operation

4. EUV Light Generation Apparatus Including Ultraviolet Light Source Provided in Obscuration Region: Second Embodiment

5. EUV Light Generation Apparatus Including Gas Supply Device and Ultraviolet Laser Device: Third Embodiment

6. EUV Light Generation Apparatus Including Gas Supply Device and Ultraviolet Laser Device: Fourth Embodiment

### 1. Overview

When a target material, such as tin, is irradiated with a laser beam, the target material may be turned into plasma. EUV light may be emitted from this plasma, and at the same time, debris of the target material may be generated. This debris may adhere onto a surface of a mirror for collecting the EUV light, and thus the reflectance of the mirror may be reduced. In the embodiments of this disclosure, an etchant gas, such as a hydrogen gas, may be supplied into a chamber and the surface of the mirror may be irradiated with ultraviolet light. Accordingly, the debris deposited on the surface of the mirror may be efficiently etched.

### 2. Overview of EUV Light Generation System

### 2.1 Configuration

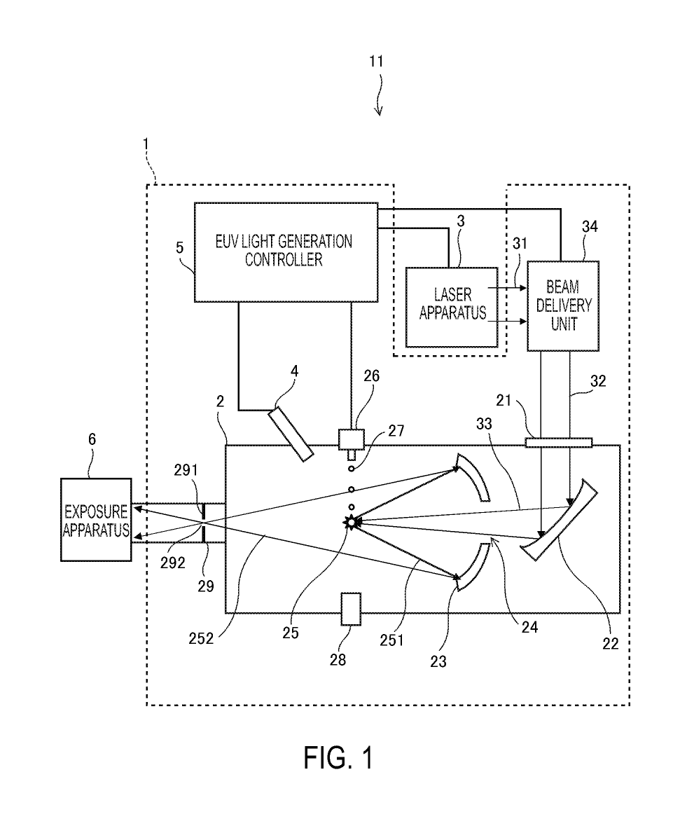

FIG. 1 schematically illustrates the configuration of an exemplary LPP type EUV light generation system. An LPP type EUV light generation apparatus 1 may be used with at least one laser apparatus 3. Hereinafter, a system that includes the EUV light generation apparatus 1 and the laser apparatus 3 may be referred to as an EUV light generation system 11. As illustrated in FIG. 1 and described in detail below, the EUV light generation system 11 may include a chamber 2 and a target supply unit. The target supply unit may be a droplet generator 26. The chamber 2 may be airtightly sealed. The target supply unit may be mounted onto the chamber 2 so as to, for example, penetrate a wall of the chamber 2. A target material to be supplied by the target supply unit may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may be provided inside the chamber 2, for example. The EUV collector mirror 23 may have a multi-layered reflective film formed on the spheroidal surface thereof. The reflective film may include a molybdenum layer and a silicon layer, which are laminated alternately. The EUV collector mirror 23 may have a first focus and a second focus, and preferably be positioned such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, the trajectory, and the position of a droplet 27.

Further, the EUV light generation system 11 may include a connection part 29 for allowing the interior of the chamber 2 and the interior of the exposure apparatus 6 to be in communication with each other. A wall 291 having an aperture may be provided inside the connection part 29, and the wall 291 may be positioned such that the second focus of the EUV collector mirror 23 lies in the aperture formed in the wall 291.

The EUV light generation system 11 may also include a beam delivery unit 34, a laser beam focusing mirror 22, and a target collector 28 for collecting droplets 27. The beam delivery unit 34 may include an optical element (not separately shown) for defining the direction into which the pulse laser beam 32 travels and include an actuator not separately shown) for adjusting the position and the orientation (posture) of the optical element.

### 2.2 Operation

With continued reference to FIG. 1, a pulse laser beam 31 outputted from the laser apparatus 3 may pass through the beam delivery unit 34 and be outputted therefrom as a pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one droplet 27 as a pulse laser beam 33.

The target supply unit, e.g., the droplet generator 26, may be configured to output the droplet(s) 27 toward the plasma generation region 25 inside the chamber 2. The droplet 27 may be irradiated with at least one pulse of the pulse laser beam 33. Upon being irradiated with the pulse laser beam 33, the droplet 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the droplet 27 may be irradiated with multiple pulses included in the pulse laser beam 33.

The EUV light generation controller 5 may be configured to integrally control the EUV light generation system 11. The EUV light generation controller 5 may be configured to process image data of the droplet 27 captured by the target sensor 4. Further, the EUV light generation controller 5 may be configured to control at least one of the timing at which the droplet 27 is outputted and the direction into which the droplet 27 is outputted. Furthermore, the EUV light generation controller 5 may be configured to control at least one of the timing at which the laser apparatus 3 oscillates, the direction in which the pulse laser beam 31 travels, and the position at which the pulse laser beam 33 is focused. It will be understood that the various controls mentioned above are merely examples, and other controls may be added as necessary.

### 3. EUV Light Generation Apparatus Including Gas Supply Device and Ultraviolet Light Source: First Embodiment

### 3.1 Configuration

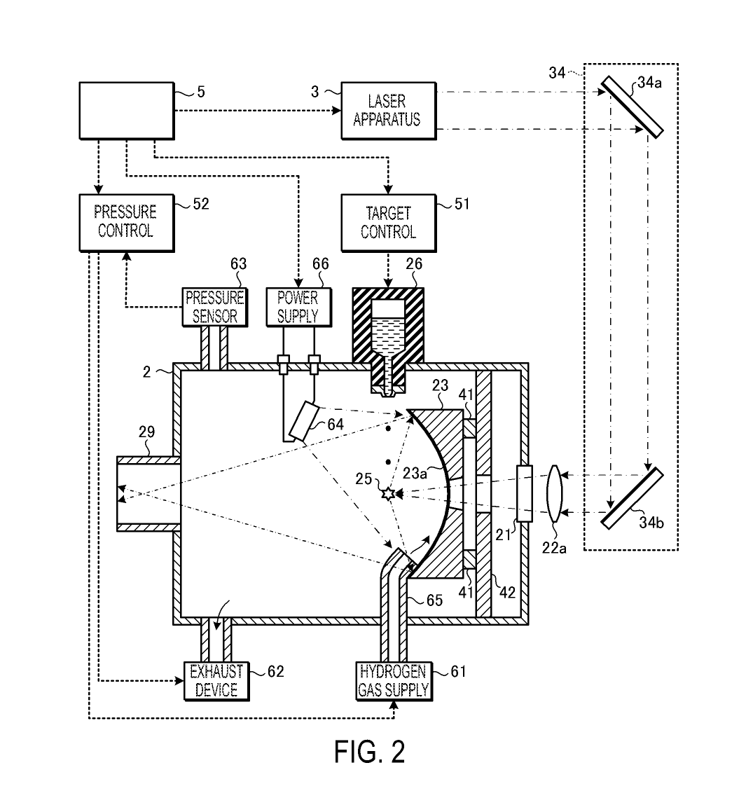

FIG. 2 schematically illustrates an example of the configuration of an EUV light generation apparatus according to a first embodiment. As shown in FIG. 2, a hydrogen gas supply device 61, an exhaust device 62, and a pressure sensor 63 may be connected to a chamber 2. An ultraviolet lamp 64 serving as an ultraviolet light source may be provided inside the chamber 2.

A plate 42 may fixed to the chamber 2, and an EUV collector mirror 23 may be attached to the plate 42 through EUV collector mirror mounts 41. The hydrogen gas supply device 61 may be connected to a pipe 65, and a leading end of the pipe 65 may be opened near a reflective surface 23a of the EUV collector mirror 23.

The ultraviolet lamp 64 may be positioned offset from a path of EUV light reflected by the EUV collector mirror 23. The ultraviolet lamp 64 may be electrically connected to a lamp power supply 66. The ultraviolet lamp 64 may output light (deep ultraviolet light) at a wavelength equal to or shorter than a wavelength (for example, 262.5 nm) having energy corresponding to bond-dissociation energy of a hydrogen molecule. That is, a hydrogen molecule irradiated with light at the aforementioned wavelength may be cleaved into hydrogen radicals. For example, the ultraviolet lamp 64 may be an excimer lamp, a low-pressure mercury lamp, a deuterium lamp, or the like. Preferably, the ultraviolet lamp 64 may be a xenon excimer lamp configured to output light (vacuum ultraviolet light) at a wavelength around 170 nm.

A beam delivery unit 34 may include a first high-reflection mirror 34a and a second high-reflection mirror 34b. A laser beam focusing optical system 22a may be provided in a beam path between the beam delivery unit 34 and the chamber 2. The laser beam focusing optical system 22a may include at least one lens and a lens position driving system (not separately shown).

The EUV light generation controller 5 may be connected to a target control device 51, a pressure control device 52, and the lamp power supply 66 through respective signal lines. The target control device 51 may be connected to a droplet generator 26 through a signal line. The pressure control device 52 may be connected to the pressure sensor 63, the hydrogen gas supply device 61, and the exhaust device 62 through respective signal lines.

### 3.2 Operation

Referring to FIG. 2, the EUV light generation controller 5 may be configured to output control signals to the target control device 51, the pressure control device 52, and the lamp power supply 66, respectively. The target control device 51 may be configured to output a control signal to the droplet generator 26. The pressure sensor 63 may be configured to detect a pressure inside the chamber 2 and output a detection signal to the pressure control device 52. The hydrogen gas supply device 61 may be configured to supply an etchant gas containing a hydrogen gas toward the reflective surface 23a of the EUV collector mirror 23 inside the chamber 2 through the pipe 65. In place of the hydrogen gas supply device 61 configured to supply a hydrogen gas, a device configured to supply an etchant gas containing other types of gas, such as hydrogen bromide (HBr), hydrogen chloride (HCl), or the like, may be used. The exhaust device 62 may discharge gas inside the chamber 2. The pressure control device 52 may be configured to control the hydrogen gas supply device 61 and the exhaust device 62 based on the detection signal from the pressure sensor 63 so that the pressure inside the chamber 2 is kept constant at a desired level. The lamp power supply 66 may be configured to supply an electric power to the ultraviolet lamp 64, so that the ultraviolet lamp 64 may emit ultraviolet light.

The reflective surface 23a of the EUV collector mirror 23 may be irradiated with the ultraviolet light from the ultraviolet lamp 64 while the hydrogen gas supplied from the hydrogen gas supply device 61 is flowing along the reflective surface 23a. Then, the hydrogen gas (H₂) may be cleaved into hydrogen radicals (H*). The hydrogen radicals may be susceptible to reacting with the target material, such as tin (Sn). When the hydrogen radicals react with tin, a stannane (SnH₄) gas may be produced. Through this reaction, tin debris deposited on the reflective surface 23a of the EUV collector mirror 23 may be etched efficiently. In order to increase the etching efficiency, the reflective surface 23a of the EUV collector mirror 23 may be coated with a catalyst.

A hydrogen radical may be short-lived, and may bond with another hydrogen radial in a short period of time to return to a hydrogen molecule. According to the first embodiment, since the hydrogen radicals may be generated near the reflective surface 23a of the EUV collector mirror 23 by irradiating the reflective surface 23a with the ultraviolet light while the hydrogen gas is present near the reflective surface 23a, a hydrogen radical may react with the debris deposited on the reflective surface 23a to produce the stannane gas before bonding with another hydrogen radical. Accordingly, the debris may be etched efficiently. Further, the hydrogen gas may flow along the reflective surface 23a of the EUV collector mirror 23. Thus, hydrogen radicals that disproportionately exist near the reflective surface 23a may be generated efficiently. Further, the EUV collector mirror 23 may be cleaned even when the generation of the EUV light is paused.

### 4. EUV Light Generation Apparatus Including Ultraviolet Light Source Provided in Obscuration Region: Second Embodiment

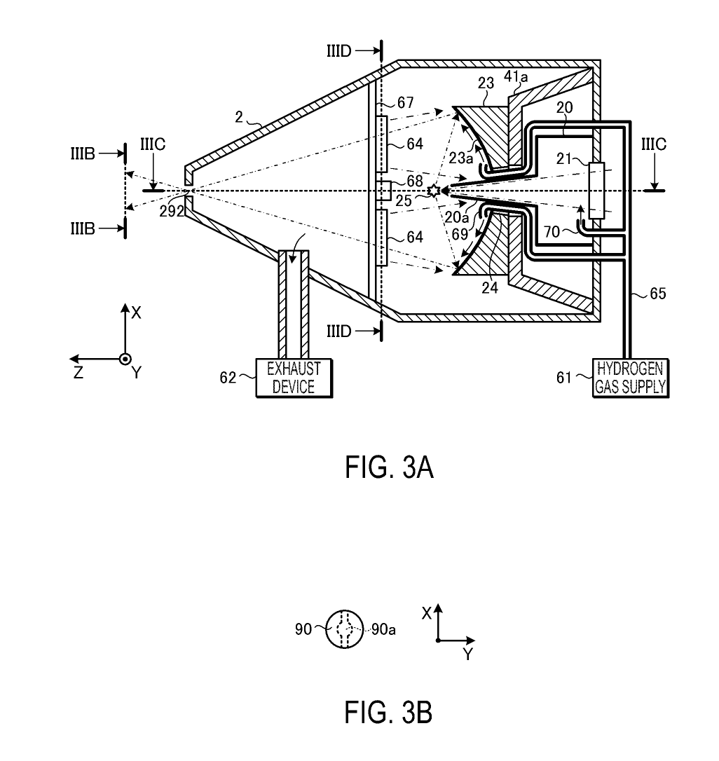

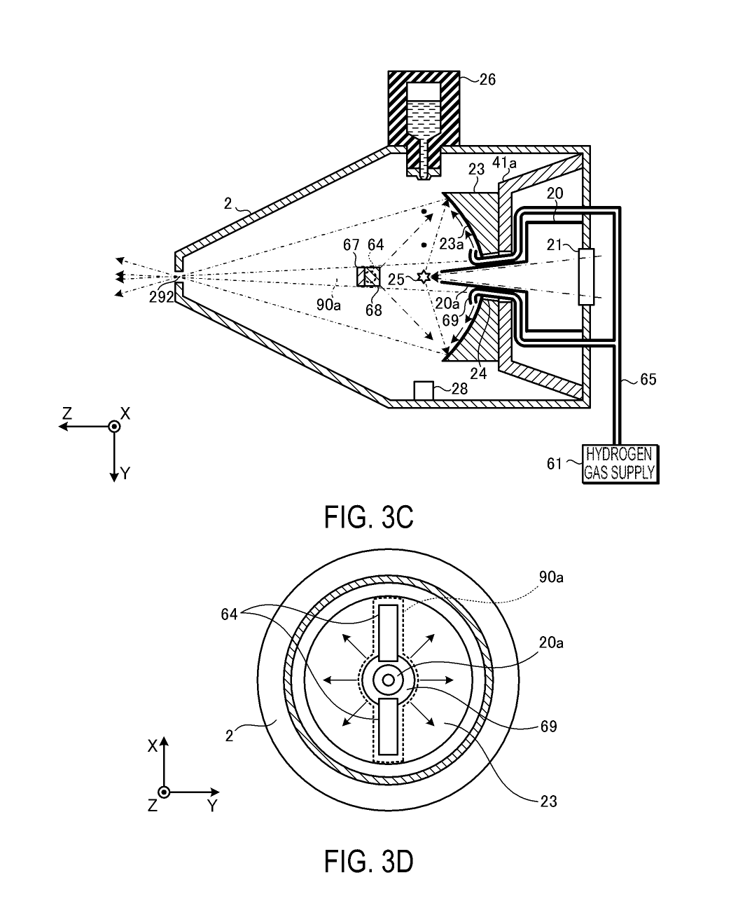

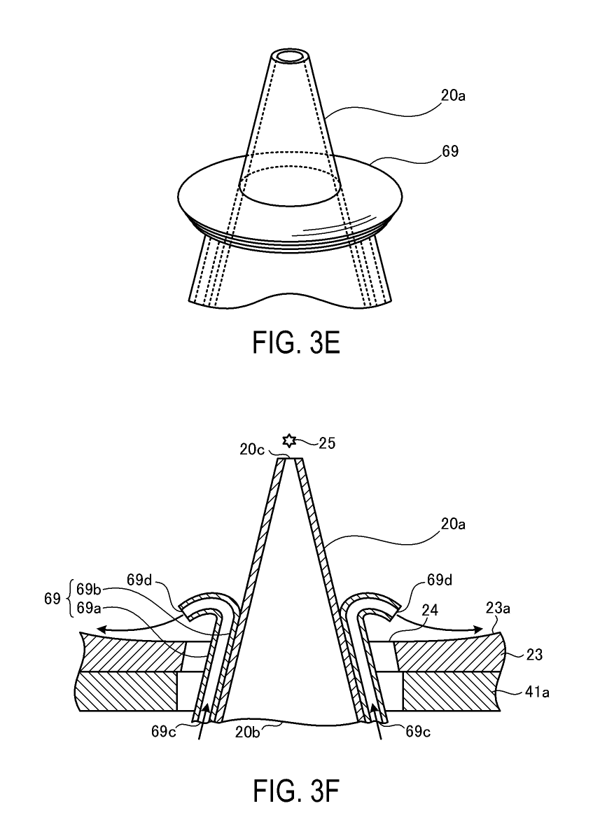

FIG. 3A schematically illustrates an example of the configuration of an EUV light generation apparatus according to a second embodiment. FIG. 3B shows a far field profile of EUV light along IIIB-IIIB plane of FIG. 3A. FIG. 3C is a sectional view schematically illustrating the configuration of the EUV light generation apparatus shown in FIG. 3A, taken along IIIC-IIIC plane. FIG. 3D is another sectional view schematically illustrating the configuration of the EUV light generation apparatus shown in FIG. 3A, taken along IIID-IIID plane. FIG. 3E is a perspective view of a pipe in a gas supply device according to the second embodiment. FIG. 3F is a sectional view of the pipe in the gas supply device according to the second embodiment.

Depending on the specifications of an exposure apparatus, a region (obscuration region) 90a that is not needed for exposure may exist in a cross-section 90 (see FIG. 3B) of the EUV light. Accordingly, in the second embodiment, the ultraviolet lamp 64 may be provided in a region corresponding to the obscuration region 90a (see FIGS. 3C and 3D) inside the chamber 2. Further, a fixing member 67 for fixing the ultraviolet lamp 64 to the chamber 2 may be provided to span across a region other than a path of the EUV light and a region corresponding to the obscuration region 90a inside the chamber 2. A beam dump 68 may further be fixed to the fixing member 67 to absorb a laser beam from the laser apparatus 3 (see FIG. 2) which has passed through the plasma generation region 25. The EUV collector mirror 23 may be fixed to the chamber 2 through an EUV collector mirror mount 41a.

Further, in the second embodiment, a sub-chamber 20 may be provided inside the chamber 2 to surround the beam path of the laser beam from the laser apparatus 3 (see FIG. 2). The sub-chamber 20 may include a conical part 20a to be inserted through the through-hole 24 formed in the EUV collector mirror 23. The conical part 20a may be a hollow member, and the laser beam travels through the interior of the conical part 20a from a bottom side 20b to a tip side 20c toward the plasma generation region 25 (see FIG. 3F).

The pipe 65 connected to the hydrogen gas supply device 61 may be connected to a pipe 69 provided in the through-hole 24 of the EUV collector mirror 23. As shown in FIG. 3F, the pipe 69 may include two members (first and second members 69a and 69b). Each of the first and second members 69a and 69b may include a body part having a shape that follows a part of the conical part 20a and a folded part continuing from the body part and extending outwardly from the body part. An inner diameter of the body part of the first member 69a may preferably be larger than an outer diameter of the body part of the second member 69b. The first and second members 69a and 69b may be fixed to each other with a spacer or the like (not separately shown) provided therebetween to secure a substantially uniform gap between the first and second members 69a and 69b. The first and second members 69a and 69b that have been assembled may define openings 69c and 69d. The opening 69c may serve as an inlet of the hydrogen gas and be located toward the rear surface side of the EUV collector mirror 23. The opening 69d may serve as an outlet for the hydrogen gas and be positioned toward the reflective surface side of the EUV collector mirror 23. The body part of the second member 69b may be fixed on the outer surface of the conical part 20b of the sub-chamber 20. The pipe 69 may be positioned such that the hydrogen gas that flows out through the opening 69d flows radially along the reflective surface 23a of the EUV collector mirror 23 from the center to the periphery thereof.

A pipe 70 (see FIG. 3A) may be connected to the pipe 65 connected to the hydrogen gas supply device 61. A leading end of the pipe 70 may be opened inside the sub-chamber 20, and the hydrogen gas may be supplied through the pipe 70 toward the vicinity of the window 21 provided on the chamber 2.

In the second embodiment, the ultraviolet lamp 64 may be provided in a region corresponding to the obscuration region, and thus a substantial reduction in the output intensity of the EUV light used for exposure may be suppressed and the reflective surface 23a of the EUV collector mirror 23 may be irradiated with the ultraviolet light efficiently. Further, since the hydrogen gas flows radially along the reflective surface of the EUV collector mirror 23 from the center to the periphery, the hydrogen gas may be supplied substantially uniformly near the reflective surface of the EUV collector mirror 23. Further, since the hydrogen gas flows inside the sub-chamber 20, debris, such as tin, deposited on the surface of the window 21 facing the interior of the chamber 2 may be etched as well. Other points may be similar to those of the first embodiment.

### 5. EUV Light Generation Apparatus Including Gas Supply Device and Ultraviolet Laser Device: Third Embodiment

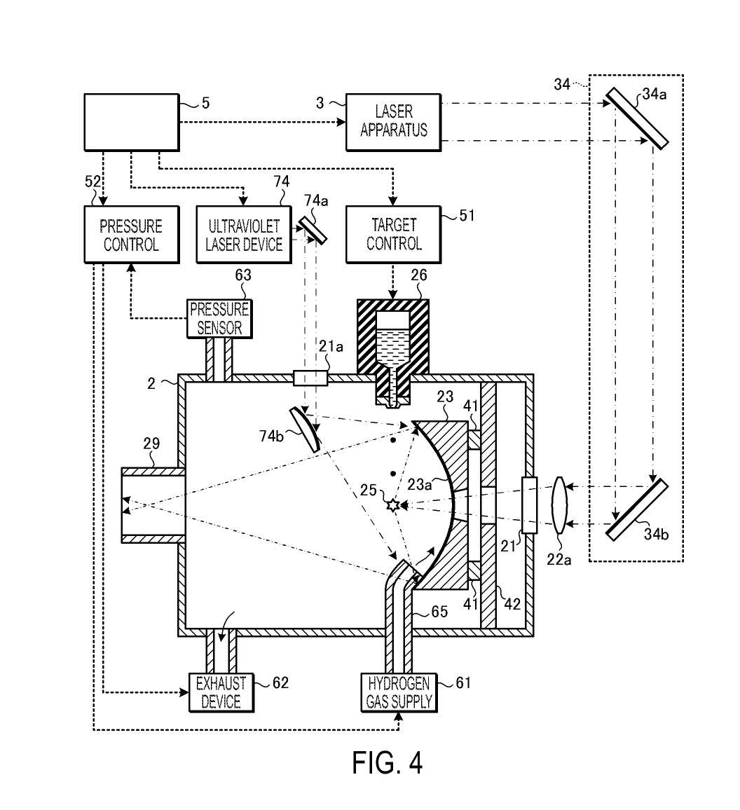

FIG. 4 schematically illustrates an example of the configuration of an EUV light generation apparatus according to a third embodiment. In the third embodiment, an ultraviolet laser device 74 provided outside the chamber 2 may be used as the ultraviolet light source. The ultraviolet laser device 74 may, for example, be an excimer laser device, such as an ArF excimer laser device configured to output a laser beam at a wavelength of 193 nm, a KrF excimer laser device configured to output a laser beam at a wavelength of 248 nm, or the like. Alternatively, the ultraviolet laser device 74 may be a solid-state laser device used with a non-linear crystal. For example, by using a device where non-linear crystals and a YAG laser device are combined, the fourth harmonic of a laser beam from the YAG laser device may be obtained.

A high-reflection mirror 74a may be provided in a beam path of an ultraviolet laser beam from the ultraviolet laser device 74. The high-reflection mirror 74a may be positioned such that the ultraviolet laser beam is reflected thereby toward a window 21a provided in the chamber 2. A convex mirror 74b may be provided inside the chamber 2. The ultraviolet laser beam transmitted through the window 21a may be incident on the convex mirror 74b. The convex mirror 74b may expand the beam diameter of the ultraviolet laser beam so that the substantially entire reflective surface 23a of the EUV collector mirror 23 is irradiated with the ultraviolet laser beam.

According to the third embodiment, since the ultraviolet light source is provided outside the chamber 2, the number of components provided inside the chamber 2 may be reduced. Further, since the ultraviolet laser device is used as the ultraviolet light source, even when the ultraviolet light source is provided outside the chamber 2, the reflective surface 23a of the EUV collector mirror 23 inside the chamber 2 may be irradiated with the ultraviolet laser beam efficiently. Other configurations and operations may be similar to those of the first or second embodiment. Here, the ultraviolet laser device may be provided inside the chamber 2, or the ultraviolet light source, such as the ultraviolet lamp, may be provided outside the chamber 2.

### 6. EUV Light Generation Apparatus Including Gas Supply Device and Ultraviolet Laser Device: Fourth Embodiment

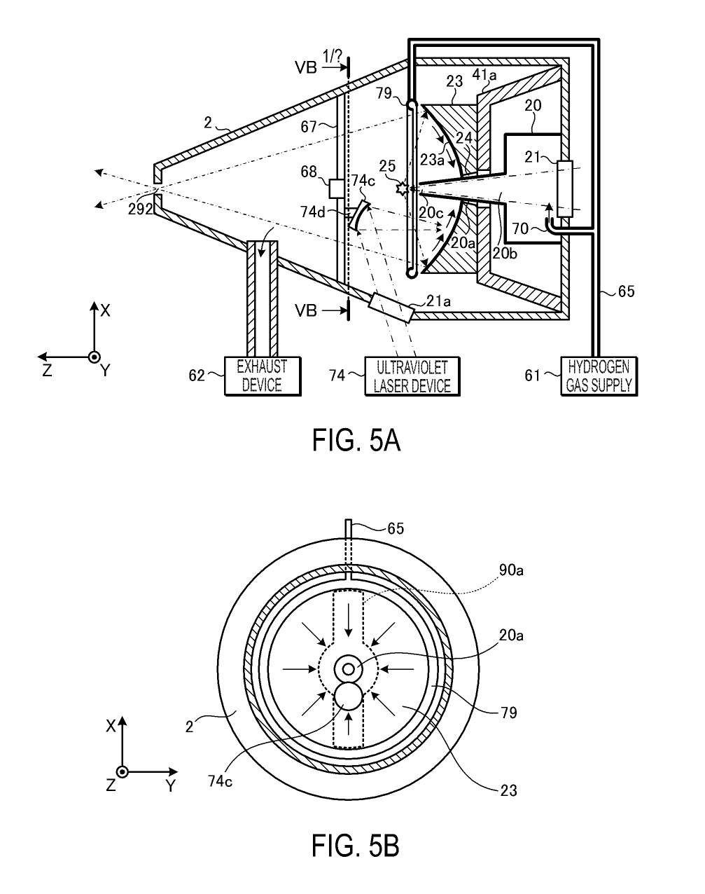

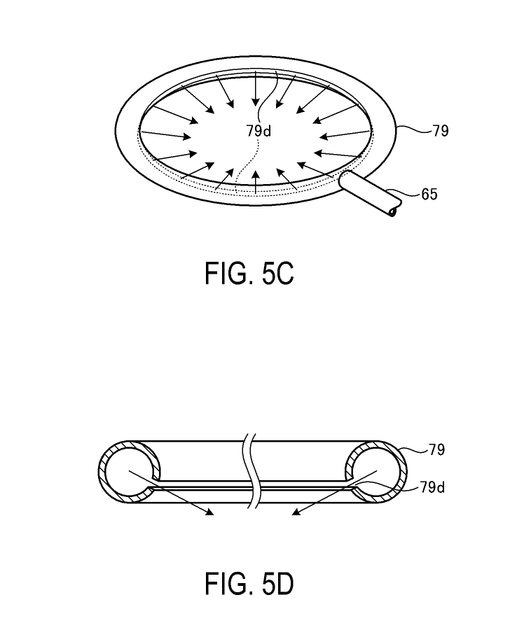

FIG. 5A schematically illustrates an example of the configuration of an EUV light generation apparatus according to a fourth embodiment. FIG. 5B is a sectional view schematically illustrating the configuration of the EUV light generation apparatus shown in FIG. 5A, taken along VB-VB plane. FIG. 5C is a perspective view of a pipe in a gas supply device according to the fourth embodiment. FIG. 5D is a sectional view of the pipe in the gas supply device according to the fourth embodiment.

In the fourth embodiment, the ultraviolet laser device 74 provided outside the chamber 2 may be used as the ultraviolet light source. The window 21a provided in the chamber 2 and a concave mirror 74c provided inside the chamber 2 may be arranged in a beam path of the ultraviolet laser beam from the ultraviolet laser device 74. The concave mirror 74c may be held by a holder 74d having an actuator (not separately shown). The orientation of the concave mirror 74c may be controlled through the actuator included in the holder 74d. The ultraviolet laser beam from the ultraviolet laser device 74 may be focused by the concave mirror 74c and applied on the reflective surface 23a of the EUV collector mirror 23. The concave mirror 74c, the holder 74d, the beam dump 68 for absorbing the laser beam from the laser apparatus 3 (see FIG. 2), and the fixing member 67 for fixing the holder 74d and the beam dump 68 may be provided in a region corresponding to the obscuration region 90a (see FIG. 5B). Alternatively, the concave mirror 74c, the holder 74d, the beam dump 68, and the fixing member 67 may be provided within a region spanning across a region other than a path of the EUV light and a region corresponding to the obscuration region 90a inside the chamber 2.

Further, in the fourth embodiment, the sub-chamber 20 may be provided inside the chamber 2 to surround the beam path of the laser beam from the laser apparatus 3 (see FIG. 2). The sub-chamber 20 may include the conical part 20a to be inserted through the through-hole 24 in the EUV collector mirror 23. The conical part 20a is a hollow member, and the laser beam travels through the interior of the conical part 20a from the bottom side to the tip side toward the plasma generation region 25 (see FIG. 3F).

Referring to FIG. 5A, the pipe 65 connected to the hydrogen gas supply device 61 may be connected to an annular pipe 79 provided near the periphery of the reflective surface of the EUV collector mirror 23. The pipe 79 may include a slit-shaped opening 79d serving as an outlet of the hydrogen gas (see FIG. 5D). The opening 79d may be provided to surround the pipe 79. The opening 79d may be provided in the inner surface of the annular pipe 79 to face the EUV collector mirror 23. With this configuration, the hydrogen gas that flows out through the opening 79d flows along the reflective surface 23a of the EUV collector mirror 23 from the periphery to the center thereof.

Here, the hydrogen gas may be supplied into the chamber 2 using the configuration shown in FIGS. 3A through 3F. Further, the configuration shown in FIGS. 5A through 5D may be applied to the embodiment shown in FIGS. 3A through 3F.

The pipe 65 connected to the hydrogen gas supply device 61 may be connected to the pipe 70. The leading end of the pipe 70 may be opened inside the sub-chamber 20 to supply the hydrogen gas toward the surface of the window 21 facing the interior of the chamber 2.

In the fourth embodiment, the orientation of the concave mirror 74c may be controlled to modify the position at which the ultraviolet laser beam is focused on the reflective surface 23a of the EUV collector mirror 23. Accordingly, the entire reflective surface 23a of the EUV collector mirror 23 may be scanned to generate the hydrogen radicals from the hydrogen gas. Further, the position at which the debris is deposited on the EUV collector mirror 23 may be identified based on an image of the reflective surface 23a obtained by an image sensor or the like (not separately shown). Then, by irradiating the identified portion with the ultraviolet laser beam, the debris may be etched efficiently. Further, by configuring the ultraviolet laser device 74 to output a high-power pulse laser beam, the debris deposited on the reflective surface 23a may be peeled off from the reflective surface 23a.

Further, in the fourth embodiment, the concave mirror 74c, the fixing member 67, and so forth may be provided in a region corresponding to the obscuration region 90a. Accordingly, a substantial reduction in the output intensity of the EUV light used for exposure may be suppressed. Further, since the hydrogen gas flows along the reflective surface 23a of the EUV collector mirror 23 from the periphery to the center, the hydrogen gas may be supplied substantially uniformly near the reflective surface 23a. Further, since the hydrogen gas flows inside the sub-chamber 20, debris, such as tin, deposited on the surface of the window 21 facing the interior of the chamber 2 may be etched as well.

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as at least one or “one or more.”

What is claimed is:

1. An apparatus for generating extreme ultraviolet (EUV) light, comprising:
a chamber;
a target supply unit configured to supply a target material to a predetermined region inside the chamber;
a collector mirror configured to collect EUV light generated from the target material;
an exhaust device connected to the chamber;
a gas supply device connected to the chamber and configured to supply an etchant gas into the chamber; and
an ultraviolet light source configured to irradiate a reflective surface of the collector mirror with ultraviolet light.

2. The apparatus according to claim 1, wherein the ultraviolet light source is configured to output at least one of deep ultraviolet light and vacuum ultraviolet light.

3. The apparatus according to claim 1, wherein the ultraviolet light source is an ultraviolet laser device.

4. The apparatus according to claim 1, wherein the ultraviolet light source is an ultraviolet lamp.

5. The apparatus according to claim 1, wherein
the ultraviolet light source is provided outside the chamber, and
the chamber has a window through which the ultraviolet light is introduced into the chamber.

6. The apparatus according to claim 1, wherein the gas supply device is configured to supply the etchant gas along the reflective surface of the collector mirror.

7. The apparatus according to claim 1, wherein the gas supply device is configured to supply the etchant gas toward the reflective surface of the collector mirror.
